(19) United States
(12) Patent Application Publication
(10) Pub. No.: US 2026/0041208 A1
(43) Pub. Date: Feb. 12, 2026

(54) Clamping Device

(71) Applicant: Yichun GE, Zhejiang (CN)

(72) Inventor: Yichun GE, Zhejiang (CN)

(21) Appl. No.: 19/365,841

(22) Filed: Oct. 22, 2025

(51) Int. Cl. A45B 11/00; A47C 7/62; A47C 7/66; F16M 13/02

(52) U.S. Cl. CPC A45B 11/00; A47C 7/622; A47C 7/664; F16M 13/022

(57) ABSTRACT

The present disclosure relates to a clamping device, comprising a U-shaped clamp body, which forms a clamping space composed of an upper clamping surface, a lower clamping surface and a lateral clamping surface. The upper clamping surface is provided with at least two fastening devices, including a rotatable clamping plate and a friction bushing; the lower clamping surface is equipped with a V-shaped recess, housing a toothed rotating wheel assembly and a magnetic clamping pad. The lateral clamping surface is retractable, connected to a fixing cylinder and a connecting plate, and fitted with a multi-directional adjustable inserting rod and a self-cleaning storage plate, with reinforcing ribs installed at key locations.

### TECHNICAL FIELD

The present disclosure relates to the technical field of clamps, particularly to a clamping device.

### BACKGROUND

Currently, clamping devices on the market for securing umbrellas to the armrests of beach chairs exhibit obvious limitations and lack of versatility in their design principles. These products were initially optimized for standardized straight-edged armrests, with their clamping surfaces typically designed as flat or simple curved structures. However, in practical applications, whether for the commonly used curved, circular, or irregularly shaped armrests of beach chairs, or for temporary anchor points like park table railings, irregular rocks, or tree branches in outdoor environments, the cross-sectional shapes are highly diverse, far exceeding the design adaptability range of existing clamping devices.

Specifically, when these traditional clamps are installed on non-flat complex curved surfaces or irregular structures, they often only achieve localized point contact, significantly reducing the actual contact area. This structural flaw leads to the following main issues: First, the clamping force distribution becomes severely uneven, causing stress concentration in localized areas, which not only reduces clamping stability but may also result in surface damage to the armrest. Second, under wind or external disturbances, relative slippage is prone to occur between the clamp and the clamped object, leading to umbrella wobbling or even complete detachment. Additionally, users often need to overtighten the clamp to enhance fixation, which increases operational burden and may cause deformation of the clamp or armrest structure due to unstable force distribution.

On the other hand, the clamping opening and profile of existing devices are typically fixed, unable to flexibly adapt to workpieces of different diameters or shapes. When faced with slightly larger or uniquely shaped armrests (e.g., square or wavy) or when attempting to use them for temporary fixation on non-target objects like table edges or railings, common issues include inability to install, insecure clamping, or complete failure.

### SUMMARY

The present disclosure provides a clamping device to address the problems raised in the background art.

To achieve the above object, the present disclosure adopts the following technical solutions:

A clamping device comprises a clamp body that is generally U-shaped and provided with a clamping space for accommodating a clamped object; wherein a bottom of the clamp body is provided with a recess; and fastening devices, at least two in number, arranged on the clamp body for applying a clamping force to the clamped object within the clamping space.

The present disclosure further provides another technical solution: a clamping device, comprising: a clamp bod that is generally U-shaped and consists of an upper clamping surface, a lower clamping surface and a lateral clamping surface; wherein the upper clamping surface is parallel to the lower clamping surface, the lateral clamping surface is perpendicular to both the upper clamping surface and the lower clamping surface, and the upper clamping surface, the lower clamping surface and the lateral clamping surface together form a clamping space; wherein a V-shaped recess is provided on the lower clamping surface; and a fastening device, at least two in number, arranged on the upper clamping surface for applying a clamping force to a clamped object within the clamping space; and the fastening device comprises: a threaded rod that passes through the upper clamping surface and is in screw-thread fit with the upper clamping surface; a handle fixedly installed at a top of the threaded rod; and a clamping plate arranged at a bottom of the threaded rod and located within the clamping space; wherein the handle is rotatable to drive the threaded rod to move the clamping plate vertically.

The present disclosure further provides another technical solution: a clamp body that is generally U-shaped and consists of an upper clamping surface, a lower clamping surface and a lateral clamping surface; wherein the upper clamping surface is parallel to the lower clamping surface, the lateral clamping surface is perpendicular to both the upper clamping surface and the lower clamping surface, and the upper clamping surface, the lower clamping surface and the lateral clamping surface together form a clamping space; wherein the lower clamping surface is provided with a V-shaped recess; and a fastening device, at least two in number, arranged on the clamp body for applying a clamping force to a clamped object within the clamping space; wherein reinforcing ribs are provided at junctions between the upper clamping surface and the lateral clamping surface, as well as between the lower clamping surface and the lateral clamping surface.

The beneficial effects of the present disclosure compared to the prior art are as follows:

The clamp body is equipped with at least two fastening devices, enabling balanced multi-point clamping for irregularly shaped workpieces, effectively preventing lifting or twisting caused by single-point force; the V-shaped recess design on the lower clamping surface ensures a firm grip on cylindrical, conical, and other irregular workpieces, while also allowing the clamping of curved armrests of beach chairs, enhancing clamping stability; the 360-degree freely rotatable clamping plate can self-adjust its angle, and combined with the high friction coefficient and soft-contact characteristics of the friction bushing, achieves non-destructive and stable clamping for various materials and complex-shaped workpieces, including smooth metals and fragile ceramics.

### BRIEF DESCRIPTION OF DRAWINGS

The drawings, which form part of this application, are provided to further illustrate the present disclosure. The illustrative embodiments and the descriptions thereof are intended to explain the present disclosure and do not constitute undue limitations. In the drawings:

FIG. 1 is a perspective schematic view of an embodiment provided by the present disclosure.

FIG. 2 is a perspective schematic view of another embodiment provided by the present disclosure.

FIG. 3 is a perspective schematic view of yet another embodiment provided by the present disclosure.

FIG. 4 is another perspective schematic diagram of the embodiment shown in FIG. 1.

FIG. 5 is a structural schematic diagram of the fastening device in the embodiment shown in FIG. 4.

FIG. 6 is an internal cross-sectional view of the fastening device in the embodiment shown in FIG. 5.

FIG. 7 is a partial exploded schematic diagram of the embodiment shown in FIG. 4.

FIG. 8 is a bottom structural schematic diagram of the embodiment shown in FIG. 3.

FIG. 9 is a structural schematic diagram of the rotating shaft and power shaft in the embodiment shown in FIG. 8.

### REFERENCE SIGNS

Clamp Body (100); Upper Clamping Surface (110); Lower Clamping Surface (120); Lateral Clamping Surface (130); Clamping Space (140); Fastening Device (200); Threaded Rod (210); Handle (220); Clamping Plate (230); Limiting Sheet (240); Friction Bushing (250); Arc-Shaped Groove (260); Fixing Cylinder (300); First Fixing Teeth (310); Connecting Plate (320); Second Fixing Teeth (330); Screw Rod (340); Grip (350); Inserting Rod (360); Storage Plate (370); Storage Rail (380); Reinforcing Rib (400); Clamping Pad (500); Rotating Shaft (600); Toothed Rotating Wheel (610); Power Shaft (620); Stop Wheel (630); Driving Gear (640); Driven Gear (650); Stop Card (660); Covering Surface (670).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

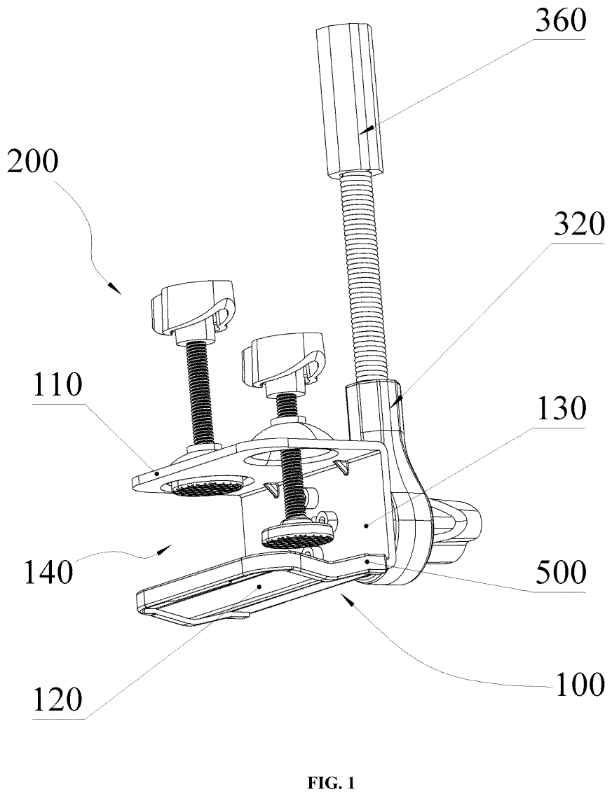

A clamping device includes a clamp body 100, which is generally U-shaped. The clamp body 100 is integrally formed by an upper clamping surface 110, a lower clamping surface 120, and a lateral clamping surface 130. The upper clamping surface 110 is parallel to the lower clamping surface 120, and the lateral clamping surface 130 is perpendicular to both the upper clamping surface 110 and the lower clamping surface 120. The upper clamping surface 110, lower clamping surface 120, and lateral clamping surface 130 together form a clamping space 140. Here, the geometric relationship of parallel upper and lower surfaces and a perpendicular lateral surface ensures that the clamping force of the clamp body 100 acts vertically on the workpiece surface, preventing clamping slippage or workpiece displacement due to angular deviation (refer to FIGS. 1, 2, and 3).

In other embodiments, as shown in FIG. 1, the middle of the lower clamping surface 120 is provided with a V-shaped recess, making the central part of the lower clamping surface 120 V-shaped. This V-shaped recess allows the lower clamping surface 120 to conform tightly to curved surfaces or edges of cylindrical, conical, or prismatic workpieces, solving the problem of slippage common with flat clamping surfaces.

In other embodiments (not shown), the lateral clamping surface 130 in this embodiment adopts a split telescopic structure, consisting of nested inner and outer plates. The inner plate has positioning holes spaced along its length, while the outer plate features spring clips at corresponding positions. By adjusting the nesting length of the inner and outer plates, the spring clips can engage different positioning holes 133, enabling overall width adjustment of the clamp body to accommodate workpieces with significant thickness variations. Additionally, reinforcing rib mounting slots are reserved at the junction of the inner and outer plates to ensure structural strength is maintained through added reinforcing ribs after telescoping.

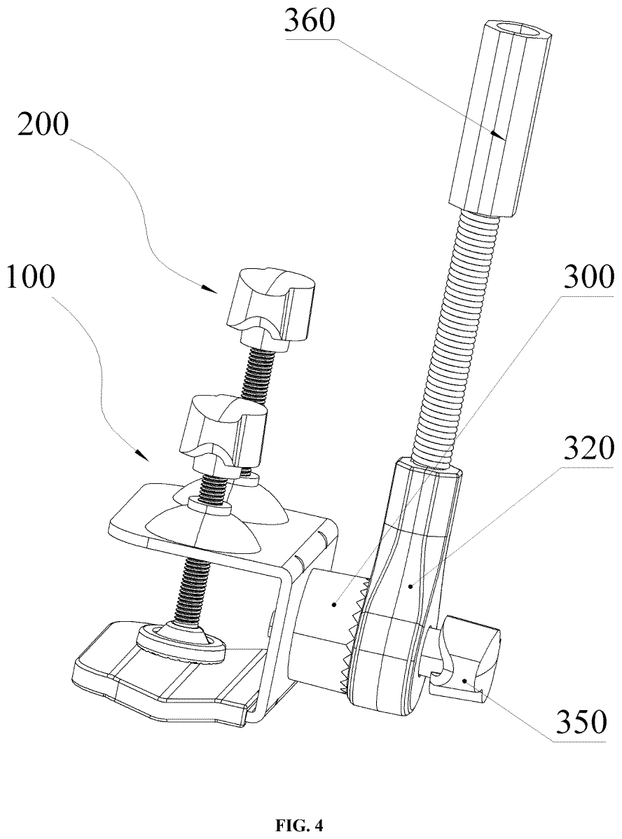

In this embodiment, please refer to FIGS. 1 and 4, where at least two fastening devices 200 are arranged on the upper clamping surface 110. By installing at least two fastening devices 200 on the upper clamping surface 110, the clamp body 100 can apply pressure to the clamped object simultaneously from two or more points. This enables stable clamping of irregularly shaped workpieces, preventing warping or rotation caused by single-point force application, and achieves clamping under various working conditions.

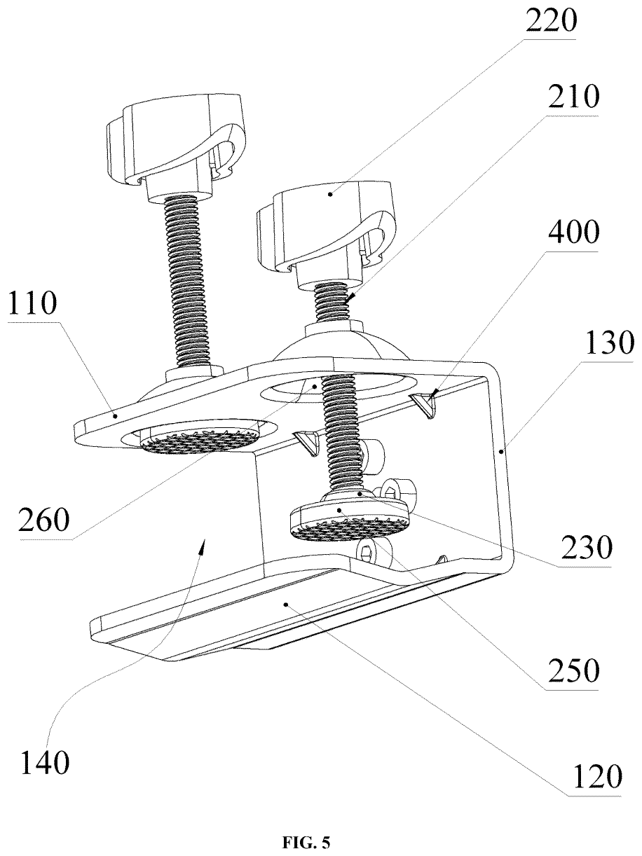

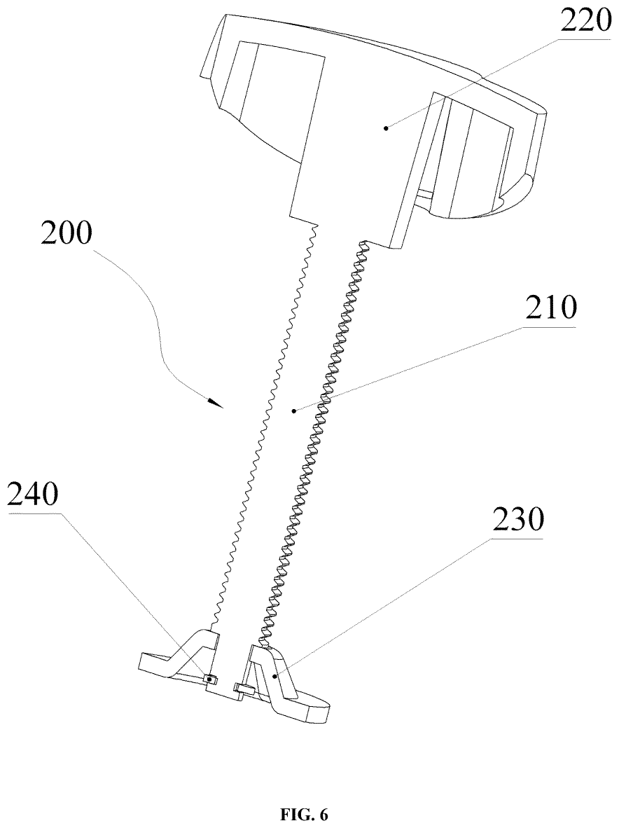

In other embodiments, please refer to FIGS. 5 and 6, where the fastening device 200 includes a threaded rod 210 inserted into the upper clamping surface 110. The top of the threaded rod 210 is fixed with a handle 220, and the bottom of the threaded rod 210, located within the clamping space 140, is equipped with a clamping plate 230. By rotating the threaded rod 210 through the handle 220, the operator can move the clamping plate 230 up and down inside the clamping space 140, causing it to move toward the lower clamping surface 120 and tightly conform to the clamped object, effectively enhancing clamping stability.

In other embodiments, please refer to FIGS. 5 and 6, where the clamping plate 230 has an equilateral trapezoidal cross-section with an opening structure at its bottom. After the threaded rod 210 passes through the clamping plate 230, a limiting sheet 240 is fixed at its end. Since the diameter of the limiting sheet 240 exceeds the aperture of the clamping plate 230, the limiting sheet 240 restricts the clamping plate 230, allowing it to rotate freely 360 degrees around the bottom of the threaded rod 210. This 360-degree rotation enables the clamping plate 230 to adjust its angle flexibly according to the workpiece shape, avoiding excessive localized force due to angular misalignment. It is particularly suitable for clamping complex-shaped workpieces such as tabletops or irregular objects.

In other embodiments, please refer to FIGS. 5 and 6, where the outer surface of the clamping plate 230 is sleeved with a friction bushing 250 made of elastic material. The high friction coefficient of the rubber material significantly increases surface friction with the clamped object. Combined with the rotational adjustment function of the clamping plate 230, it effectively prevents workpiece displacement under force, especially for smooth surfaces (e.g., metal, glass). Additionally, the elasticity of the rubber bushing 250 cushions clamping pressure, avoiding scratches or indentations caused by direct contact with the clamping plate 230. This provides targeted protection for precision parts, coated components, or brittle materials (e.g., ceramics, plastics).

In other embodiments, referring to FIGS. 5 and 6, the bottom surface of the upper clamping surface 110 is provided with an arc-shaped groove 260 that matches the shape of the clamping plate 230. When the clamping plate 230 moves into the arc-shaped groove 260, the bottom surface of the external friction bushing 250 can align flush with the bottom surface of the upper clamping surface 110, forming a smooth stowed state. The stowage design of the arc-shaped groove 260 provides protection for the clamping plate 230 and friction bushing 250 during non-operational conditions, reducing impact wear during idle periods and extending the service life of vulnerable components.

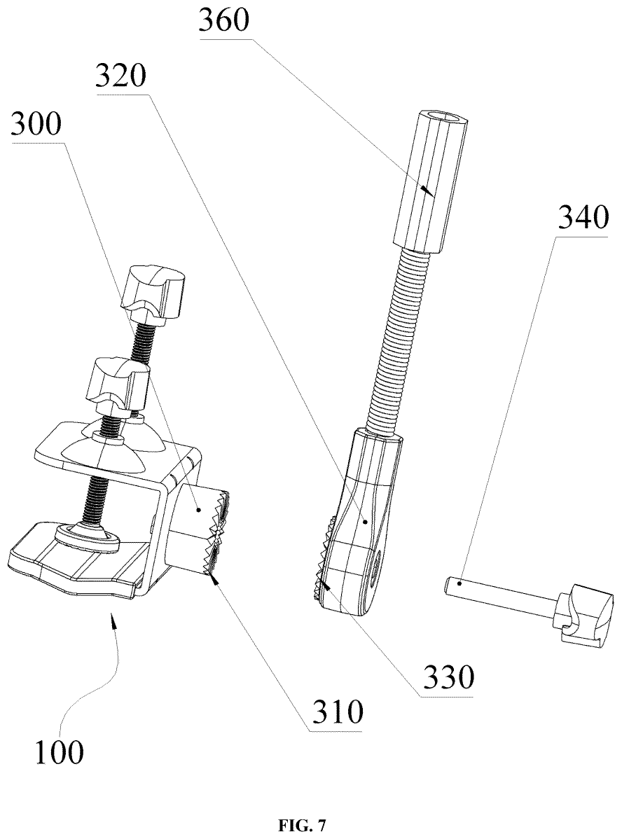

In this embodiment, referring to FIGS. 4 and 7, the side of the lateral clamping surface 130 facing away from the clamping space 140 is equipped with a fixing cylinder 300. One end of the fixing cylinder 300, distal to the lateral clamping surface, is fitted with first fixing teeth 310. A connecting plate 320 is provided to cooperate with it, and the surface of the connecting plate 320 facing the fixing cylinder is equipped with second fixing teeth 330. The fixing cylinder 300 and the connecting plate 320 are securely connected through the meshing of the first fixing teeth 310 and the second fixing teeth 330.

In other embodiments, referring to FIGS. 4 and 7, a screw rod 340 is inserted into the fixing cylinder 300 through threaded engagement. One end of the screw rod 340 movably penetrates the connecting plate 320, and a grip 350 is fixedly installed at its distal end.

When it is necessary to lock and secure the connecting plate 320, the operator rotates the grip 350 to drive the screw rod 340. Due to the threaded engagement between the screw rod 340 and the fixing cylinder 300, the rotational motion is converted into axial lateral movement of the screw rod 340, thereby pushing or pulling the connecting plate 320 to tightly mesh its second fixing teeth 330 with the first fixing teeth 310 on the fixing cylinder 300. This ultimately achieves a stable connection between the connecting plate 320 and the fixing cylinder 300. The threaded transmission provides a mechanical force amplification effect, allowing the application and precise control of substantial locking force through the rotation of the grip 350. This ensures very firm tooth engagement, effectively preventing loosening under vibration or load.

In other embodiments, referring to FIGS. 4 and 7, an inserting rod 360 is fixedly installed at the top of the connecting plate 320, which can be used to mount a sunshade umbrella or other similar accessory devices. The middle section of the inserting rod 360 is designed with elastic material or an elastic structure, giving it a certain degree of bendability. The elastic middle section allows the inserting rod 360 and the installed sunshade umbrella to flex and buffer under strong winds, effectively dissipating external forces. This prevents the umbrella or clamping fixture from breaking or toppling due to rigid resistance, significantly enhancing adaptability and stability in variable outdoor environments.

In other embodiments, referring to FIGS. 4 and 7, the fixing cylinder 300 is fixedly installed on the lateral clamping surface 130 through at least four bolts. The installation of the fixing cylinder 300 with bolts allows workers to disassemble it at any time for maintenance.

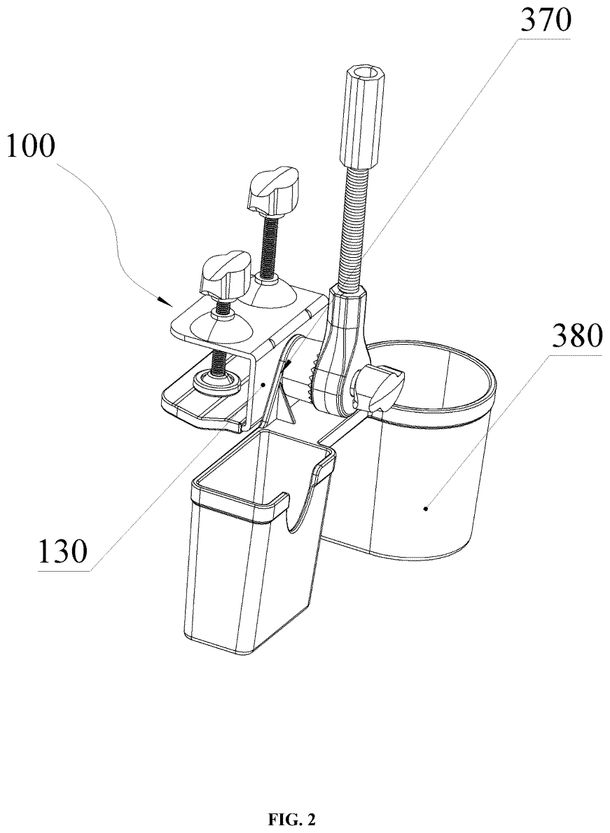

In other embodiments, referring to FIG. 2, a storage plate 370 is arranged between the fixing cylinder 300 and the lateral clamping surface 130. The storage plate 370 is installed using the same set of bolts for the fixing cylinder 300 and is integrated with multiple storage rails 380, which can be used to temporarily place mobile phones, small tools, or other personal items. By sharing existing bolts for installation, the storage plate 370 eliminates the need for additional connection holes or structures on the clamp body, preserving its integrity and strength while ensuring simple installation and a compact, tidy overall structure.

In this embodiment, referring to FIG. 5, at least two reinforcing ribs 400 are fixedly installed at the junctions between the upper clamping surface 110 and the lateral clamping surface 130, as well as between the lower clamping surface 120 and the lateral clamping surface 130. By placing reinforcing ribs 400 at the stress concentration points, the clamp body 100's resistance to bending and torsional deformation is significantly enhanced, preventing the opening from “expanding” or deforming under strong clamping force. This ensures clamping stability. Additionally, the reinforcing ribs distribute the load on the main structure, greatly reducing the risk of metal fatigue, thereby improving the product's durability and reliability for long-term, high-intensity use.

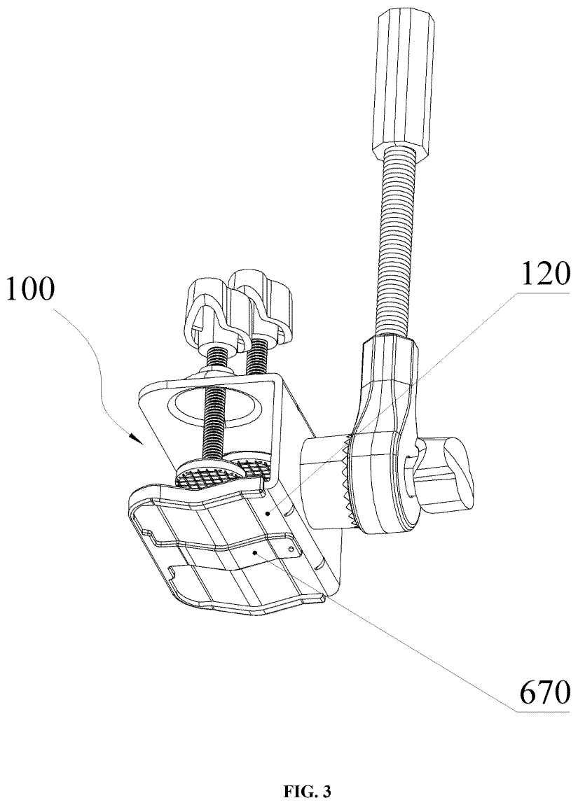

In this embodiment, referring to FIGS. 1 and 3, a clamping pad 500 is sleeved on the lower clamping surface 120.

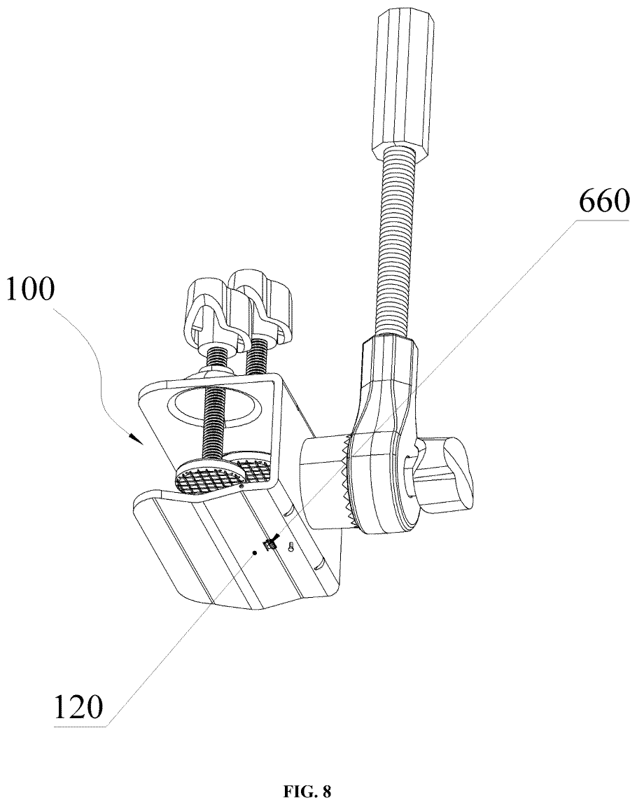

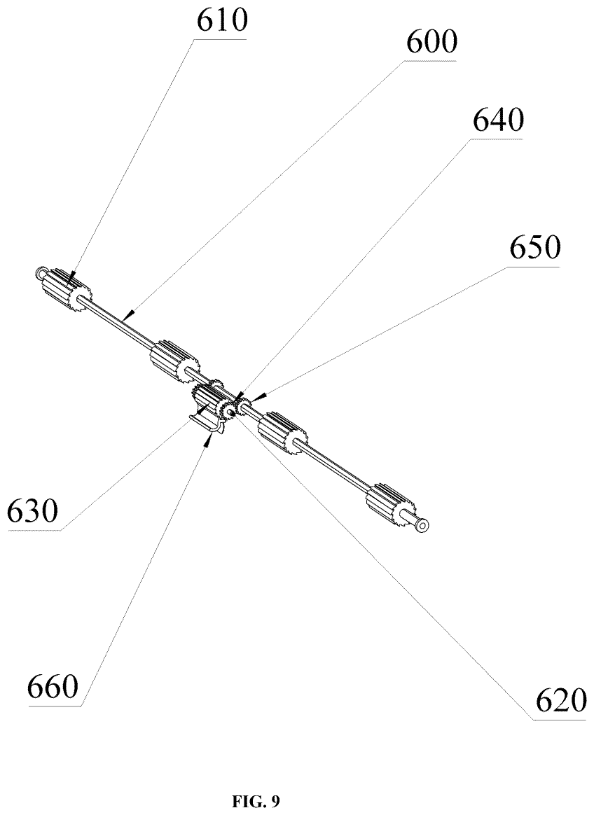

In other implementations, referring to FIGS. 8 and 9, a cavity is formed inside the lower clamping surface 120, and a rotating shaft 600 is rotatably installed between the inner walls on both sides of the cavity. Multiple toothed rotating wheels 610 are fixedly sleeved on the surface of the rotating shaft 600 at intervals, with their teeth arranged counterclockwise. The tops of the toothed rotating wheels 610 extend outside the lower clamping surface 120 and contact the clamping pad 500.

Inside the lower clamping surface 120, below the rotating shaft 600, a power shaft 620 is installed, on which a stop wheel 630 and a driving gear 640 are fixed. The structure of the stop wheel 630 is identical to that of the toothed rotating wheel 610. A driven gear 650, meshing with the driving gear 640, is fixed at the corresponding position on the rotating shaft 600. By driving the power shaft 620 to rotate, the rotating shaft 600 can be synchronized, enabling the counterclockwise teeth of the toothed rotating wheels 610 to effectively lock the clamping pad 500 and prevent it from falling off.

In other embodiments, referring to FIG. 9, a stop card 660 is arranged inside the cavity. One end of the stop card 660 is engaged between the teeth of the stop wheel 630, while the other end extends outside the lower clamping surface 120. Under normal working conditions, this card restricts the rotation of the stop wheel 630, thereby preventing the power shaft 620 and the engaged rotating shaft 600 from rotating, ensuring the toothed rotating wheel 610 remains fixed in position and the clamping pad 500 is securely held in the clamping position. When replacing or removing the clamping pad 500, the operator pulls the stop card 660 radially outward to disengage it from the teeth of the stop wheel 630, releasing the rotational restriction on the entire gear train. At this point, the rotating shaft 600 can rotate freely, allowing the clamping pad 500 to be smoothly removed.

The stop card 660 achieves one-way locking through mechanical interference. When embedded between the teeth of the stop wheel 630, it utilizes the tooth side surfaces to bear counterclockwise rotational torque, forming a mechanical self-lock. This locked state is transmitted through the gear transmission chain from the stop wheel 630 to the driving gear 640, then to the driven gear 650 and rotating shaft 600, ultimately applying a clamping force to the clamping pad 500. To release the lock, this mechanical interference is removed through external operation to restore system freedom.

In other embodiments, as shown in FIG. 3, the bottom of the clamping pad 500 extends with a strip-shaped covering surface 670. One end of this covering surface 670 is mounted to the underside of the lower clamping surface 120 through a snap-fit structure, fully covering the stop card 660 beneath it and preventing direct exposure to the external environment. This protective covering effectively avoids accidental disengagement of the stop card 660 due to unintended contact, ensuring stability and safety during clamping.

In this embodiment (not shown), the connection between the clamping pad 500 and the lower clamping surface 120 is changed to a magnetic attachment method: an annular permanent magnet is embedded on the inner side of the clamping surface, while an iron plate is correspondingly placed on the back of the clamping pad 500, enabling quick replacement through magnetic adhesion. The clamping pad 500 can be made of different materials as needed, such as: textured rubber pads (enhanced friction), suede pads (protecting painted workpieces), or high-temperature-resistant silicone pads (suitable for high-temperature environments). Additionally, the edges of the clamping pad 500 feature pull rings for easy removal, addressing the laborious disassembly issue of traditional snap-fit structures.

In summary, the above description demonstrates that the present disclosure achieves the following technical effects:

The clamp body 100 is equipped with at least two fastening devices 200, enabling multi-point balanced clamping for irregularly shaped workpieces, effectively preventing warping or twisting caused by single-point stress; the V-shaped recess design of the lower clamping surface 120 securely grips various non-standard workpieces like cylinders and cones, while also clamping the curved armrests of beach chairs, enhancing clamping stability; the 360-degree freely rotatable clamping plate 230 adaptively adjusts angles, and combined with the high friction coefficient and soft-contact characteristics of the friction bushing, achieves damage-free and stable clamping for various materials and complex-shaped workpieces, including smooth metals and fragile ceramics.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ”, “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. A clamping device, comprising:
a clamp body that is generally U-shaped and provided with a clamping space for accommodating a clamped object;
wherein a bottom of the clamp body is provided with a recess; and
fastening devices, at least two in number, arranged on the clamp body for applying a clamping force to the clamped object within the clamping space.

2. The clamping device according to claim 1, wherein the clamp body is composed of an upper clamping surface, a lower clamping surface and a lateral clamping surface, with the upper clamping surface parallel to the lower clamping surface and the lateral clamping surface perpendicular to both the upper clamping surface and the lower clamping surface, the clamping space being formed by the upper clamping surface, the lower clamping surface and the lateral clamping surface.

3. The clamping device according to claim 2, wherein the recess is V-shaped and located on the lower clamping surface.

4. The clamping device according to claim 2, wherein the lower clamping surface is sleeved with a clamping pad.

5. The clamping device according to claim 2, wherein the fastening device comprises:
a threaded rod that passes through the upper clamping surface and is in screw-thread fit with the upper clamping surface;
a handle fixedly installed at a top of the threaded rod; and
a clamping plate arranged at a bottom of the threaded rod and located within the clamping space;
wherein the handle is rotatable to drive the threaded rod to move the clamping plate vertically.

6. The clamping device according to claim 5, wherein a friction bushing is sleeved over outer surface of the clamping plate.

7. The clamping device according to claim 6, wherein an arc-shaped groove matching a shape of the clamping plate is provided on a bottom surface of the upper clamping surface; and
wherein when the clamping plate moves into the arc-shaped groove, a bottom surface of the friction bushing outside the clamping plate can align flush with the bottom surface of the upper clamping surface.

8. The clamping device according to claim 5, wherein an opening is provided at a top of the clamping plate, an end of the threaded rod passes through the opening and is accommodated within the opening, and a limiting sheet is fixedly installed at the end of the threaded rod; and
wherein a size of the limiting sheet is larger than an aperture of the opening, thereby rotatably limiting the clamping plate at the end of the threaded rod.

9. The clamping device according to claim 5, wherein reinforcing ribs are provided at junctions between the upper clamping surface and the lateral clamping surface, as well as between the lower clamping surface and the lateral clamping surface.

10. A clamping device, comprising:
a clamp bod that is generally U-shaped and consists of an upper clamping surface, a lower clamping surface and a lateral clamping surface;
wherein the upper clamping surface is parallel to the lower clamping surface, the lateral clamping surface is perpendicular to both the upper clamping surface and the lower clamping surface, and the upper clamping surface, the lower clamping surface and the lateral clamping surface together form a clamping space;
wherein a V-shaped recess is provided on the lower clamping surface; and
a fastening device, at least two in number, arranged on the upper clamping surface for applying a clamping force to a clamped object within the clamping space; and
the fastening device comprises:
a threaded rod that passes through the upper clamping surface and is in screw-thread fit with the upper clamping surface;
a handle fixedly installed at a top of the threaded rod; and
a clamping plate arranged at a bottom of the threaded rod and located within the clamping space;
wherein the handle is rotatable to drive the threaded rod to move the clamping plate vertically.

11. The clamping device according to claim 10, wherein a friction bushing is sleeved over an outer surface of the clamping plate.

12. The clamping device according to claim 11, wherein an arc-shaped groove matching a shape of the clamping plate is provided on a bottom surface of the upper clamping surface; and
wherein when the clamping plate moves into the arc-shaped groove, a bottom surface of the friction bushing outside the clamping plate can be flush with the bottom surface of the upper clamping surface.

13. The clamping device according to claim 10, wherein the top of the clamping plate is provided with an opening, the end of the threaded rod passes through the opening and is accommodated within the opening, and a limiting sheet is fixedly installed at the end of the threaded rod; and
wherein the size of the limiting sheet is larger than the aperture of the opening, thereby rotatably limiting the clamping plate at the end of the threaded rod.

14. The clamping device according to claim 10, wherein reinforcing ribs are provided at junctions between the upper clamping surface and the lateral clamping surface, as well as between the lower clamping surface and the lateral clamping surface.

15. A clamping device, comprising:
a clamp body that is generally U-shaped and consists of an upper clamping surface, a lower clamping surface and a lateral clamping surface;
wherein the upper clamping surface is parallel to the lower clamping surface, the lateral clamping surface is perpendicular to both the upper clamping surface and the lower clamping surface, and the upper clamping surface, the lower clamping surface and the lateral clamping surface together form a clamping space;
wherein the lower clamping surface is provided with a V-shaped recess; and
a fastening device, at least two in number, arranged on the clamp body for applying a clamping force to a clamped object within the clamping space;
wherein reinforcing ribs are provided at junctions between the upper clamping surface and the lateral clamping surface, as well as between the lower clamping surface and the lateral clamping surface.

16. The clamping device according to claim 15, wherein a friction bushing is sleeved over an outer surface of the clamping plate.

17. The clamping device according to claim 16, wherein an arc-shaped groove matching a shape of the clamping plate is provided on a bottom surface of the upper clamping surface; and
wherein when the clamping plate moves into the arc-shaped groove, a bottom surface of the friction bushing outside the clamping plate can be flush with the bottom surface of the upper clamping surface.

18. The clamping device according to claim 15, wherein a top of the clamping plate is provided with an opening, an end of the threaded rod passes through the opening and is accommodated within the opening, and a limiting sheet is fixedly installed at the end of the threaded rod; and
wherein a size of the limiting sheet is larger than an aperture of the opening, thereby rotatably limiting the clamping plate at the end of the threaded rod.
